(19) United States
(12) Patent Application Publication
(10) Pub. No.: US 2014/0257897 A1
(43) Pub. Date: Sep. 11, 2014

(54) RESPONDER PERSONNEL ON-CALL AVAILABILITY SYSTEM

(71) Applicant: Page-Out, LLC, (unknown)

(72) Inventors: Carlos Fernandez, Jr., Newton, KS (US); Stephen B. Owens, Hesston, KS (US)

(73) Assignee: PAGE-OUT, LLC

(21) Appl. No.: 13/786,075

(22) Filed: Mar. 5, 2013

(51) Int. Cl. G06Q 10/06

(52) U.S. Cl. CPC G06Q 10/063114
USPC 705/7.15

(57) ABSTRACT

A system for monitoring an availability status of responder personnel comprises a server and a plurality of electronic devices. The server is configured to maintain a list of responder personnel names and an availability status associated with each name. The server executes a server application which displays a first web page including a first on-screen availability object for establishing the availability status of a responder, such that activating the first on-screen availability object establishes the availability status of the responder as of the moment the first on-screen availability object is activated. The electronic devices are configured to communicate with the server. Each device executes a mobile application which includes a second on-screen availability object for establishing the availability status of the responder, such that activating the second on-screen availability object establishes the availability status of the responder as of the moment the second on-screen availability object is activated.

### BACKGROUND OF THE INVENTION

1. Field of the Invention

Embodiments of the current invention relate to systems for establishing an availability status of responder personnel.

2. Description of the Related Art

Responder personnel may work for fire stations, police stations, or medical centers and may include emergency personnel, first responders, fire personnel, law enforcement personnel, medical personnel, and the like. While the responder personnel are within the building of the station or the medical center, they are, by default, considered to be available to respond to an emergency or critical situation. When the responder personnel leave the building, they may be on-call, meaning that they are still considered available to respond to an emergency or critical situation. In other settings, the responders may be volunteers and thus, may be on-call indefinitely. As long as a responder stays in a local area and does not engage in time-consuming activities, he may remain on-call. However, for a number of reasons, the responder may need to change his status to be unavailable. Alternatively, the responder who was previously unavailable may suddenly become available and wish to change his status.

Traditionally, when a responder wished to change or update his on-call status, he may have called the station or medical center. An operator would have taken his status information and updated a database that includes responders with associated on-call statuses. However, placing a phone call takes time and errors could occur in recording the status of the responder as a result of distractions or numerous calls placed to the operator. Responders now may send a text message to indicate their on-call status. But, texting also takes time, and the message has to be parsed by either a human or a computer. The human again may make errors in properly recording the status, while the computer may not properly record the status if the responder made errors in typing.

### SUMMARY OF THE INVENTION

Embodiments of the current invention solve the above-mentioned problems and provide a distinct advance in the art of systems for establishing an availability status of responder personnel. More particularly, embodiments of the invention provide systems and methods for establishing an availability status of responder personnel that are quick and easy to use and that eliminate the possibility of errors.

Various embodiments of the current invention provide a system for monitoring an availability status of responder personnel. The system broadly comprises a server and a plurality of electronic devices. The server is configured to maintain a list of responder personnel names and an availability status associated with each name. The server executes a server application which displays a first web page including a first on-screen availability object for establishing the availability status of a responder, such that activating the first on-screen availability object establishes the availability status of the responder as of the moment the first on-screen availability object is activated. The electronic devices are configured to communicate with the server. Each device executes a mobile application which includes a second on-screen availability object for establishing the availability status of the responder, such that activating the second on-screen availability object establishes the availability status of the responder as of the moment the second on-screen availability object is activated.

Other embodiments of the current invention provide a computer readable storage medium with an executable program stored thereon for monitoring an availability of responder personnel. The program may instruct a processing element to perform the following steps: accessing a database to retrieve a list of responder personnel names and an availability status associated with each name, displaying on a screen of an electronic device the list of responder personnel names and an indication of the availability status of each name, displaying on the screen an on-screen availability object for establishing the availability status of a responder, and receiving an activation of the on-screen availability object from the responder which establishes the availability status of the responder as of the moment the on-screen availability object is activated.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a system that may be used for monitoring an availability of responder personnel, in accordance with various embodiments of the current invention;

FIG. 2 is a schematic block diagram of components of a server;

FIG. 3 is a schematic block diagram of components of an electronic device;

FIG. 4 is a screen capture of a first page of a server application of the system;

FIG. 5 is a screen capture of a second page of the server application;

FIG. 6 is a screen capture of a third page of the server application;

FIG. 7 is a screen capture of a fourth page of the server application;

FIG. 8 is a screen capture of a fifth page of the server application;

FIG. 9 is a screen capture of a sixth page of the server application;

FIG. 10 is a screen capture of a seventh page of the server application;

FIG. 11 is a screen capture of an eighth page of the server application;

FIG. 12 is a screen capture of a ninth page of the server application;

FIG. 13 is a screen capture of a first page of a mobile application of the system;

FIG. 14 is a screen capture of a second page of the mobile application;

FIG. 15 is a screen capture of a third page of the mobile application;

FIG. 16 is a screen capture of a first version of a fourth page of the mobile application;

FIG. 17 is a screen capture of a second version of the fourth page of the mobile application;

FIG. 18 is a screen capture of a fifth page of the mobile application;

FIG. 19 is a screen capture of a sixth page of the mobile application; and

FIG. 20 is a screen capture of a seventh page of the mobile application.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

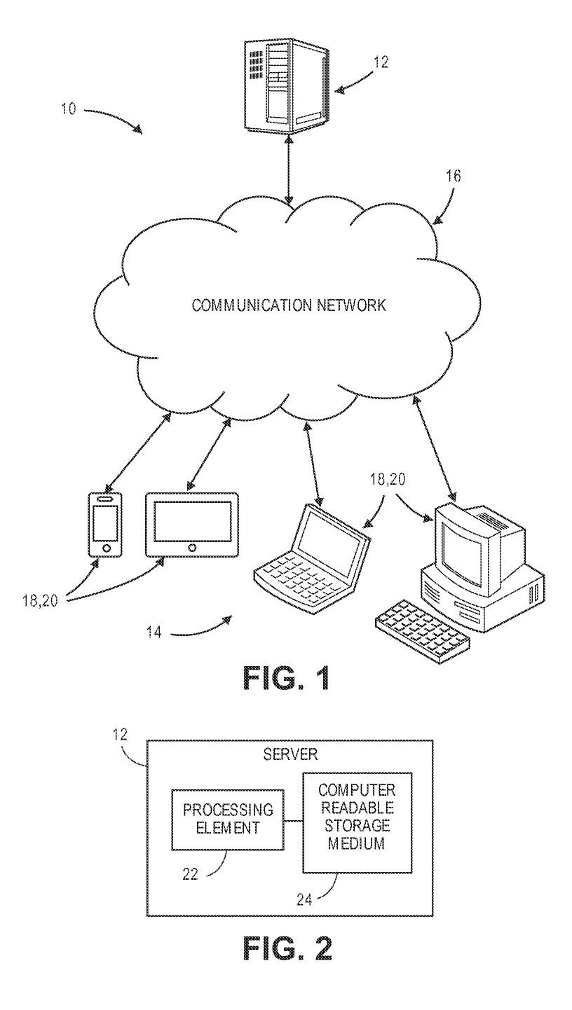

A system 10 that may be used for monitoring an availability of responder personnel, constructed in accordance with various embodiments of the current invention, is shown in FIG. 1. The system 10 may be utilized by public service providers such as fire stations, police stations, hospitals and medical centers with emergency rooms, and the like. The responder personnel may be full-time, part-time, or volunteer and may include emergency personnel, first responders, fire personnel, law enforcement personnel, medical personnel, and the like. The availability may refer to the responder personnel being available to respond to an emergency or critical situation, such as a fire, a vehicle accident, an emergency surgical procedure, or the like. More broadly, the system 10 could be utilized by any company or service provider that maintains personnel who are on-call. The responders may include repair personnel, such as plumbers or electricians, technical personnel, such as computer or information technology specialists, or personnel who are part time, such as contract workers. The situations to which these personnel respond may not be life threatening but may impact business or cause damage to a home or building. Various aspects of the current invention may be implemented in hardware, firmware, software, or combinations thereof. The system 10 may broadly comprise a server 12, a plurality of electronic devices 14, and a communication network 16.

The server 12 generally stores electronic data and may include application servers, database servers, file servers, gaming servers, mail servers, print servers, web servers, or the like, or combinations thereof. Furthermore, the server 12 may include a plurality of servers, virtual servers, or combinations thereof. In some embodiments, the server 12 may be physically separated or isolated from the electronic devices 14. In other embodiments, the server 12 may be included with, retained by, or executed on one or more of the electronic devices 14. The server 12 may be configured to include or execute software such as a database, web server applications, or the like.

The server 12 may include a processing element 22 in electronic communication with a computer readable storage medium 24, as shown in FIG. 2. The processing element 22 may include microprocessors, microcontrollers, digital signal processors (DSPs), field-programmable gate arrays (FPGAs), analog and/or digital application-specific integrated circuits (ASICs), and the like, or combinations thereof. The processing element 22 may generally execute, process, or run instructions, code, software, firmware, programs, applications, apps, services, daemons, or the like, or may step through states of a finite-state machine.

The computer readable storage medium 24 may include data storage components such as read-only memory (ROM), programmable ROM, erasable programmable ROM, random-access memory (RAM), hard disks, floppy disks, optical disks, flash memory, thumb drives, universal serial bus (USB) drives, and the like, or combinations thereof. The computer readable storage medium 24 may store the instructions, code, software, firmware, programs, applications, apps, services, daemons, or the like that are executed by the processing element 22. The computer readable storage medium 24 may also store settings, data, documents, sound files, photographs, movies, images, databases, and the like. The processing element 22 may be in communication with the computer readable storage medium 24 through address busses, data busses, control lines, and the like.

The electronic devices 14 generally include devices or components used by individuals such as smart phones, tablets, laptop computers, desktop computers, work station computers, personal digital assistants (PDAs), cell phones, or the like, or combinations thereof. The electronic devices 14 may allow a responder to establish, maintain, or modify his availability status. The electronic devices 14 typically include devices to which the responder has access either on demand or on a regular basis. In some embodiments, the electronic devices 14 are mobile and are able to be carried by the responder such as in a pocket, purse, backpack, or the like. Furthermore, the electronic devices 14 may include a display 18 with a screen 20 for displaying information, data, images, and the like. Typically, the electronic devices 14 also include input components such as pointing devices, keyboards, mice, keypads, touch pads, touch screens, and the like.

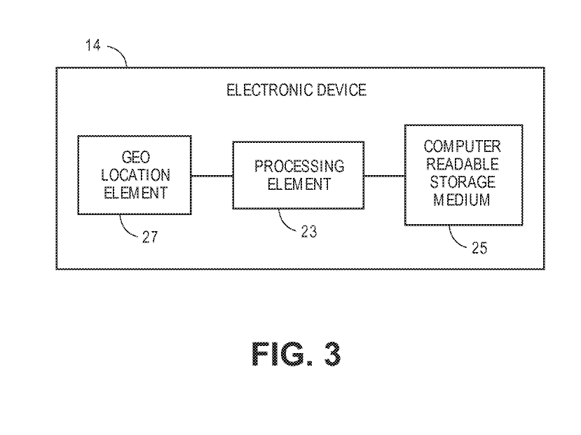

Each electronic device 14 may include a processing element 23 in electronic communication with a computer readable storage medium 25, as shown in FIG. 3. The processing element 23 and the computer readable storage medium 25 may be substantially similar to the processing element 22 and computer readable storage medium 24 discussed above.

Each electronic device 14 may further include a geo location element 27 for determining the current geographical location of the electronic device 14. The geo location element 27 may be a satellite navigation receiver that works with a global navigation satellite system (GNSS) such as the global positioning system (GPS) primarily used in the United States, the GLONASS system primarily used in the Soviet Union, or the Galileo system primarily used in Europe. The geo location element 27 may include an antenna to assist in receiving the satellite signals. The antenna may be a patch antenna, a linear antenna, or any other type of antenna that can be used with location or navigation devices. The geo location element 27 may further include one or more processors, controllers, or other computing devices and memory so that it may calculate location and other geographic information.

Although embodiments of the geo location element 27 may include a satellite navigation receiver, it will be appreciated that other location-determining technology may be used. For example, cellular towers or any customized transmitting radio frequency towers can be used instead of satellites may be used to determine the location of the electronic device 14 by receiving data from at least three transmitting locations and then performing basic triangulation calculations to determine the relative position of the device with respect to the transmitting locations. With such a configuration, any standard geometric triangulation algorithm can be used to determine the location of the electronic device. The geo location element 27 may also include or be coupled with a pedometer, accelerometer, compass, or other dead-reckoning components which allow it to determine the location of the device 14.

The geo location element 27 may be in electronic communication with the processing element 23 and the computer readable storage medium 25. The geo location element 27, the processing element 23, or the combination of the two may be utilized to determine when the electronic device 14 is located within a predetermined area. The predetermined area may be an on-call area for given unit or department inside of which, the responder may be available or on-call, and outside of which, the responder may not be available. The on-call area coordinates may be stored on the server 12 and may be downloaded to each electronic device 14. In at least one embodiment, the processing element 23 may receive the current location coordinates from the geo location element 27 and may receive the on-call area coordinates from the computer readable storage medium 25. The processing element 23 may then compare the current location coordinates with the on-call area coordinates and determine whether the electronic device 14 (and hence, the responder who owns the device 14) is within the on-call area.

The communication network 16 generally allows communication between the electronic devices 14 and the server 12 as well as communication from one electronic device 14 to another. The communication network 16 may include local area networks, metro area networks, wide area networks, cloud networks, the Internet, and the like, or combinations thereof. The communication network 16 may also include or connect to voice communication systems such as cellular networks and public ordinary telephone systems. The communication network 16 may be wired, wireless, or combinations thereof and may include components such as switches, routers, hubs, access points, and the like. The electronic devices 14 may connect to the communication network 16 either through wires, such as electrical cables or fiber optic cables, or wirelessly, such as radio frequency (RF) communication using wireless standards such as Bluetooth® or the Institute of Electrical and Electronic Engineers (IEEE) 802.11.

The server 12 may process, run, or execute a server application 26 that monitors the availability status of responder personnel. In various embodiments, portions of the server application 26 may be created using a markup language, such as hypertext markup language (HTML), and may be implemented as an Internet-based web site. Thus, the server application 26 may be accessed using a web browser, web viewer, or Internet browser, as are all known in the art, which is executed on an electronic device 14. The server application 26 may include a database or a list of names of the responder personnel. The database may be a database coupled with a database management system, as is known in the art. Associated with each name may be information such as an identification number, an email address, a phone number, an association identifier such as a department name or group name, and the like. Also associated with each name may be an availability status, a responding status, a page out time of day, a page out duration, and the like. It may be possible to associate additional fields or information with each name as well.

The availability status may be an on-call availability status and may have values such as “available” or “unavailable”. The responding status may indicate whether a responder is responding for each emergency call and may have values such as “yes” or “no”. Alternatively, both the availability status and the responding status may be simple binary variables that have a value of either one or zero. Furthermore, both the availability status and the responding status may be given default values. For example, the availability status may have a default value of unavailable or zero, while the responding status may have a default value of no or zero. The page out time of day may indicate the time of day at which the responder set his availability status to unavailable, or “paged out” as is sometimes known. The page out duration may indicate the period of time for which the responder may be unavailable and may have a value in minutes or hours or may have a value of “off-duty”.

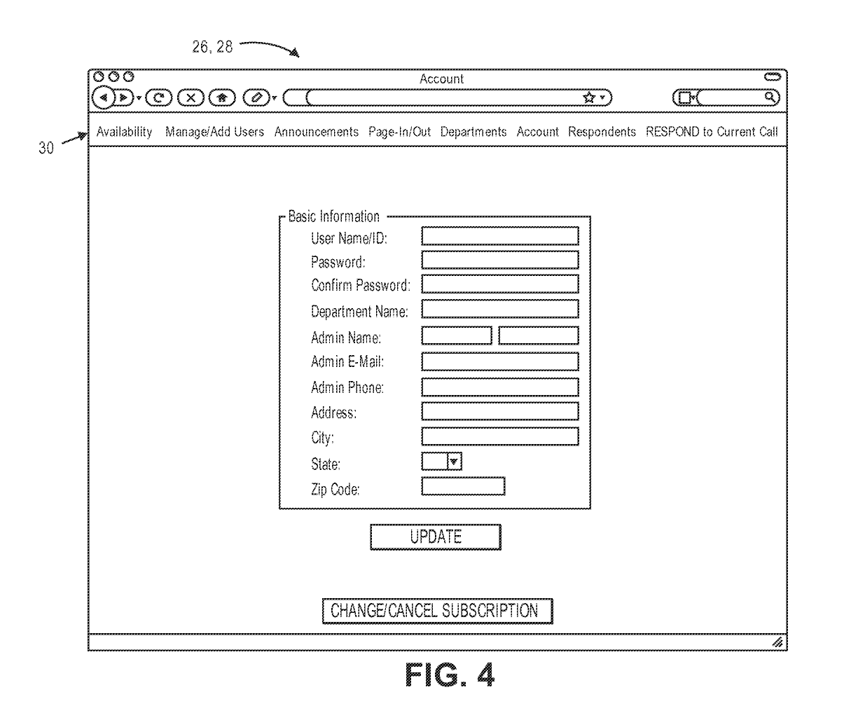

The server application 26 may also allow a user, such as an information technology administrator at a fire station, police station, or medical facility, to set up, administer, and maintain the database. The server application 26 may display a first page 28 that allows the administrator to enter information to establish an account, as shown in FIG. 4. The server application 26 may also display a menu bar 30 with a plurality of options that allows the administrator, or other user, to navigate the web site. Clicking on the options presents the user with subsequent pages described below.

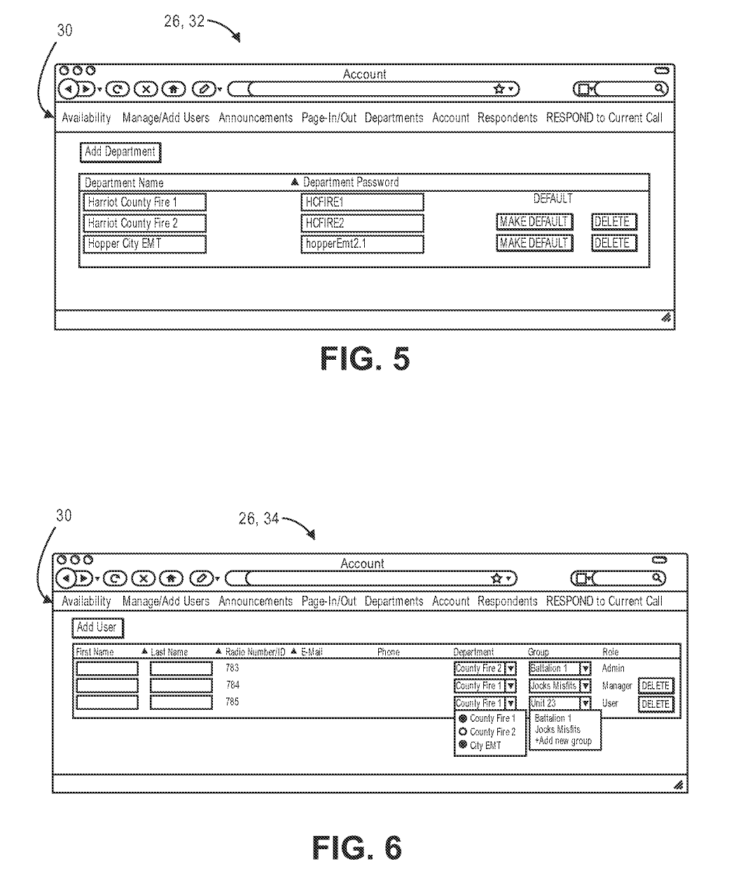

The server application 26 may display a second page 32 that allows the administrator to enter information regarding various departments of the organization, as shown in FIG. 5. The server application 26 may display a third page 34 that allows the administrator to enter information associated with the responder personnel described above, as shown in FIG. 6.

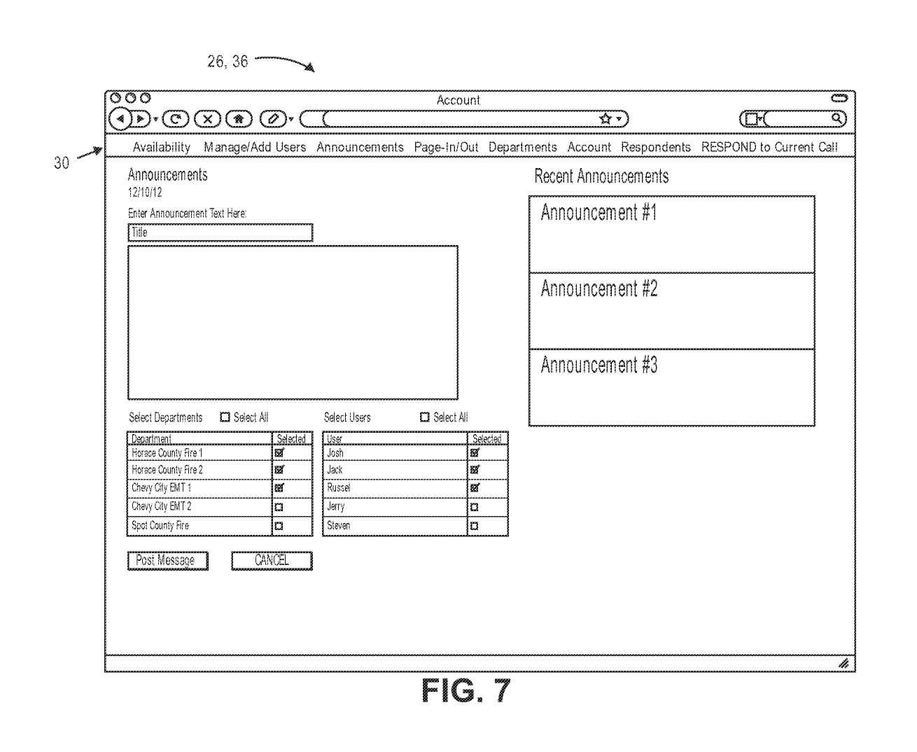

The server application 26 may further allow the administrator to post announcements or news regarding the organization and may display a fourth page 36, as shown in FIG. 7, that allows the administrator to enter the news and to select which departments and/or responder personnel receive the information.

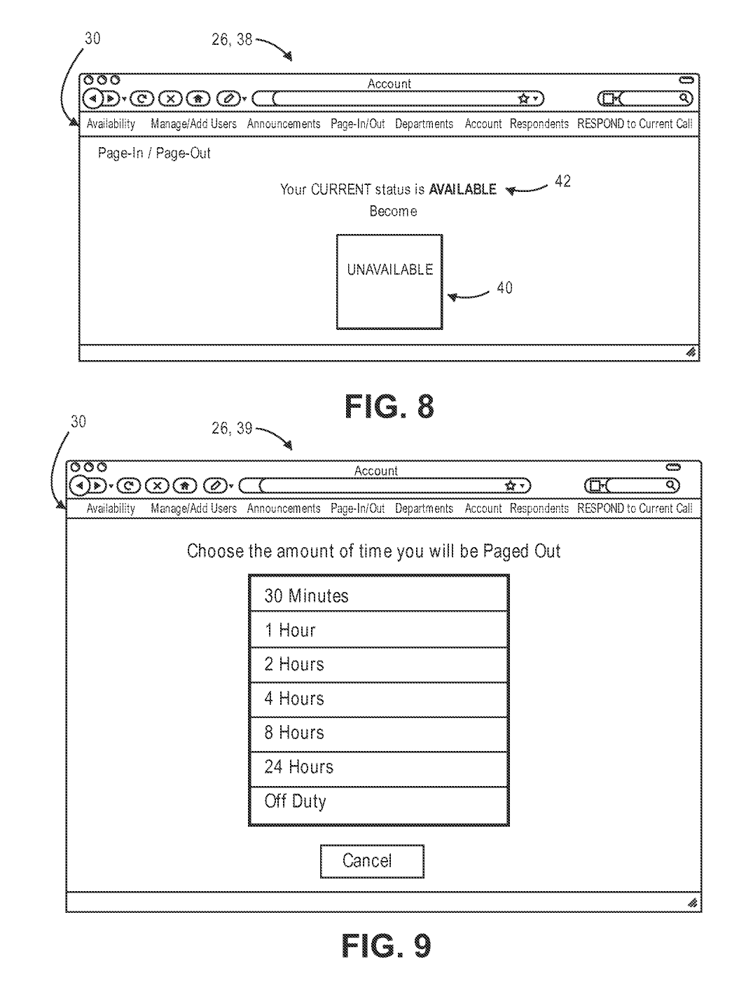

In addition, the server application 26 may allow the responder to establish or modify his availability status and may display a fifth page 38 which has a first on-screen availability object 40 for establishing the availability status of the responder and a first current status indicator 42 for indicating the current availability status of the responder, as shown in FIG. 8. The first on-screen availability object 40 may be displayed with a geometric shape, such as a box, a rectangle, or other shape, and may be isolated, highlighted, or centered on the screen 20. The first current status indicator 42 may include words that indicate the current availability status, such as “available” or “unavailable”, but may include other indictors like a check or an “X”. Activating the first on-screen availability object 40, by either clicking on it with a pointing device, such as a mouse, or touching it on a touch screen, toggles the availability status associated with the name of the responder in the database. Activating the first on-screen availability object 40 also toggles the first current status indicator 42. If the availability status has a value of available, then activating the first on-screen availability object 40 may change the availability status and the first current status indicator 42 to unavailable. Whenever the responder changes his status from available to unavailable, the server application 26 may display a sixth page 39, as shown in FIG. 9, which prompts the responder to select the amount of time for which he will be unavailable. The time chosen by the responder will then be the value of the page out duration in the database associated with the name of the responder. Furthermore, the server application 26 may record the time of day at which the responder changed his availability status and may assign that time to the page out time of day field in the database. Activating the first on-screen availability object 40 again may revert the availability status and the first current status indicator 42 to available.

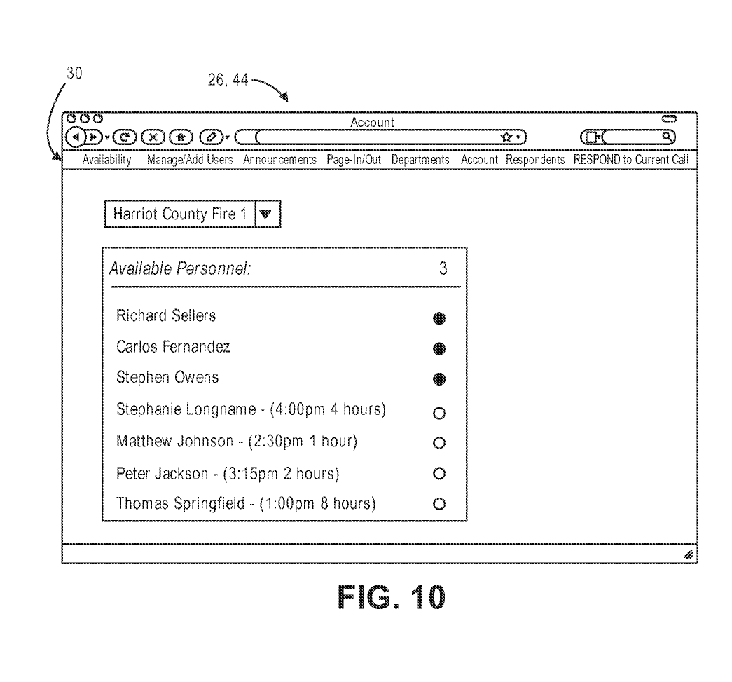

The server application 26 may also display a list of selected responder personnel along with the availability status of each one. The user may select “Availability” from the menu bar 30 and a seventh page 44 may be displayed that shows a list, such as from a pull-down menu, of departments or other groups of responder personnel, as shown in FIG. 10. The user may select a department or group and a list may be displayed with the names of the selected responder personnel as well as the availability status, the page out time of day, and the page out duration of each one. The list may be sorted according to status, and the availability status may be indicated by a color of the names. For example, the responder personnel who are available may be presented in a first color while those who are unavailable may be presented in a second color. The availability status may also be indicated by the words “Available” and “Unavailable” next to the names, as appropriate. Optionally, the availability status may be indicated by geometric shapes, such as a solid circle or a check mark for the responder personnel who are available and an open circle or an “X” for those who are not. In addition, the seventh page 44 may display an indication of the total number of responder personnel who are currently available.

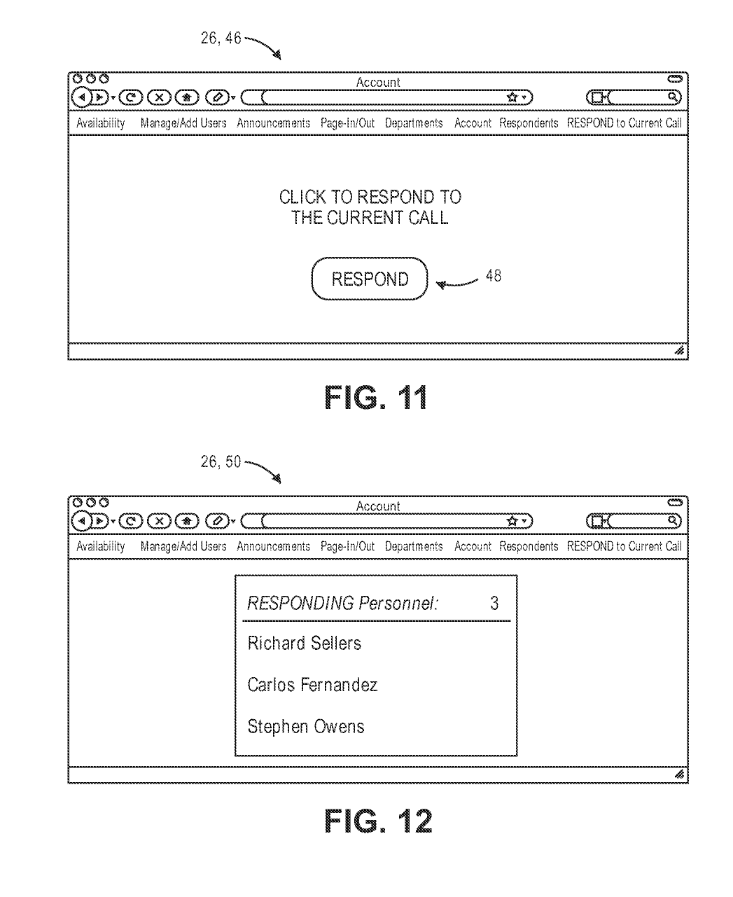

The server application 26 may allow the responder to respond to a current emergency call. The responder may select “RESPOND to Current Call” from the menu bar 30, and the server application 26 may display an eighth page 46 which includes a first on-screen respond object 48, as shown in FIG. 11. The eighth page 46 may also include identification numbers or other information relevant to the responder. The first on-screen respond object 48 may have a geometric shape, such as a box, a rectangle, a circle, an ellipse, or the like, and may be isolated, highlighted, or centered on the screen 20. The first on-screen respond object 48 may also include text, such as the word “RESPOND”. The first on-screen respond object 48 may be activated by either clicking on it with a pointing device, such as a mouse, or touching it on a touch screen. Activating the first on-screen respond object 48 may change the responding status associated with the name of the responder in the database to yes, one, or an equivalent affirmative value.

For any given emergency call, a user may view a list of personnel who have indicated that they are responding. The user may select “Respondents” from the menu bar 30, and the server application 26 may display a ninth page 50, as shown in FIG. 12, which includes a list of names of responder personnel whose responding status is yes. The ninth page 50 may also display an indication of the total number of personnel who are responding to the emergency call. The server application 26 may update the list as the responders respond to the call by activating the first on-screen respond object 48, discussed above.

The electronic devices 14 may process, run, or execute a mobile application 52 that establishes, maintains, or modifies the availability status of the responder. The mobile application 52 may include a unique identifier, such as a user name, identification number, or the like, or combinations thereof, that identifies the user of the electronic device 14 and the mobile application 52. The unique identifier may be embedded in or accessed by the mobile application 52. Thus, the user may not necessarily log in to the mobile application 52 in order to be properly identified. In some embodiments, the mobile application 52 may communicate with the server application 26 at regular intervals to retrieve information, such as status information and the like. In other embodiments, the server application 26 may automatically transmit information to all electronic devices 14, and the mobile applications 52 running thereon, whenever any information is changed or updated. In still other embodiments, a combination of both communication approaches may be utilized.

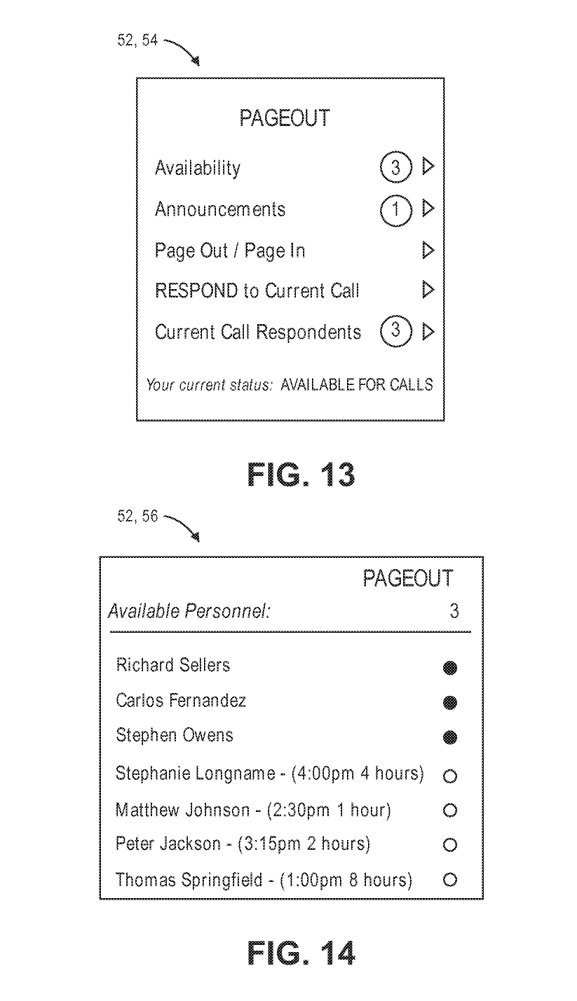

The mobile application 52 may display a first page 54, as shown in FIG. 13, with a plurality of options. In addition, the first page 54 may display an indication of the current availability status of the user. In various embodiments, the mobile application 52 may retrieve the current availability status of the user from the server application 26. The user may select an “Availability” option to view a list of responder personnel and their availability status. The mobile application 52 may display a second page 56, shown in FIG. 14, similar to the seventh page 44 of the server application 26. The second page 56 may display a listing of responder personnel of the user's department or group as well as the availability status, the page out time of day, and the page out duration of each responder. As discussed above, the availability status may be indicated in a plurality of ways. The second page 56 may also display an indication of the total number of responder personnel who are currently available.

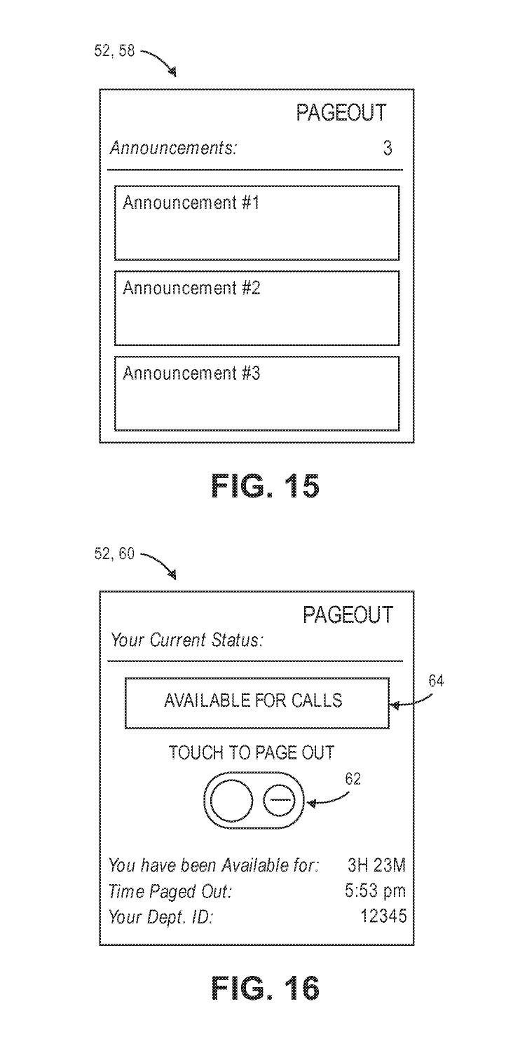

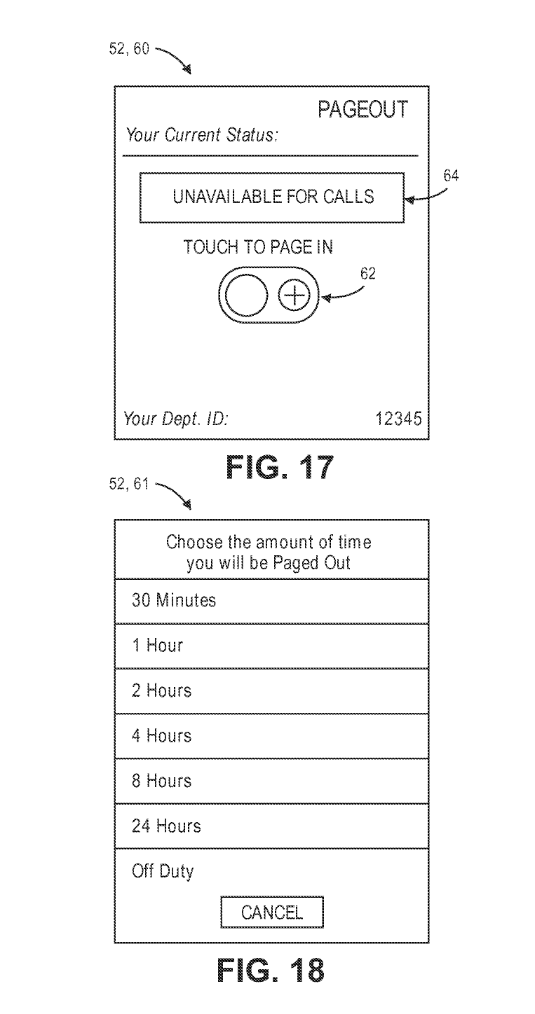

The user may select an “Announcements” option from the first page 54 to view announcements relevant to his department or group, as seen on a third page 58 in FIG. 15. The user may select a “Page Out/Page In” option from the first page 54 to adjust his availability status. The mobile application 52 may present a fourth page 60, shown in FIGS. 16-17, which includes a second on-screen availability object 62, substantially similar to the first on-screen availability object 40, and a second current status indicator 64. In various embodiments of the mobile application 52, the second on-screen availability object 62 may be displayed with the shape of a button, although other shapes are possible. In addition, the second current status indicator 64 may include words that indicate the current availability status, such as “available” or “unavailable”, but may include other indictors like a check or an “X”. The second on-screen availability object 62 may be activated, by clicking on it with a pointing device, such as a mouse, or by touching it on a touch screen, in order to toggle the availability status and the second current status indicator 64. For example, if the current status is available, as seen in FIG. 16, and the user activates the second on-screen availability object 62, then the status and the second current status indicator 64 are changed to unavailable, as seen in FIG. 17. Whenever the responder changes his status from available to unavailable, the mobile application 52 may display a fifth page 61, as shown in FIG. 18, which prompts the responder to select the amount of time for which he will be unavailable. The time chosen by the responder will then be the value of the page out duration in the database associated with the name of the responder. Furthermore, the mobile application 52 may record the time of day at which the responder changed his availability status and may assign that time to the page out time of day field in the database. Activation of the second on-screen availability object 62 may further cause the mobile application 52 to send a signal, an instruction, or data to the server application 26 to change the availability status, the page out time of day, and the page out duration associated with the current responder in the database. The mobile application 52 may also send a signal, an instruction, or data to the server application 26 that indicates the identity of the current responder, such as a user name or identification number.

The fourth page 60 may also include an indication of the amount of time that the current status has been active, the time of day at which the last change of status occurred, an identification number, and the like.

As mentioned above, the processing element 23 in combination with the geo location element 27 of each electronic device 14 may determine whether the responder and his electronic device 14 are within the on-call area. This function may be performed as part of the mobile application 52. If the responder is within the area, then nothing may occur. However, if the responder is outside of the on-call area, then the mobile application 52 may automatically change the availability status of the responder to unavailable. Thus, the mobile application 52 may send a signal, an instruction, or data to the server application 26 to change the availability status associated with the current responder in the database to unavailable. Furthermore, the mobile application 52 may update all of the on-screen status indicators on the electronic device 14 and may display an alert or a prompt to the responder that his status has changed.

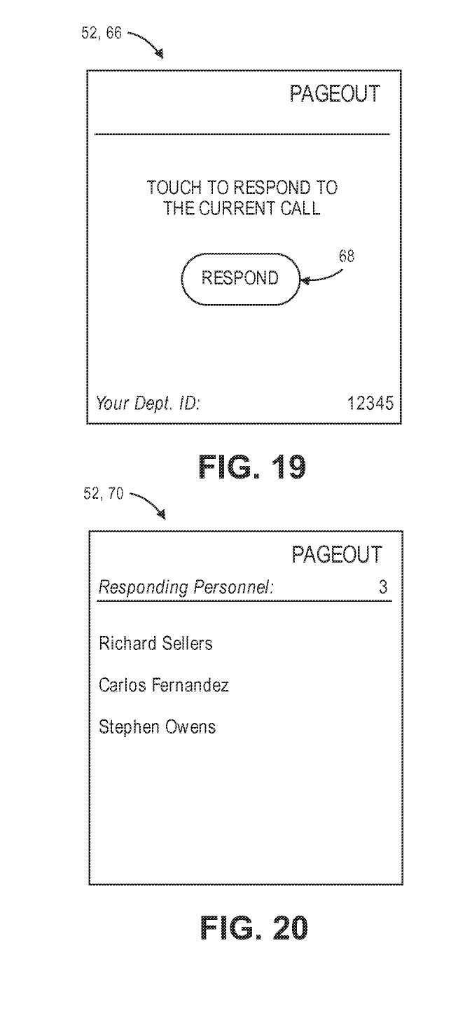

The mobile application 52 may allow the responder to respond to a current emergency call. The user may select a “RESPOND to Current Call” option from the first page 54, and the mobile application 52 may display a sixth page 66 which includes a second on-screen respond object 68, as shown in FIG. 19. The second on-screen respond object 68 may be substantially similar to the first on-screen respond object 48 in appearance. Activating the second on-screen respond object 68 may prompt the mobile application 52 to send a signal, an instruction, or data that includes the responding status and an identifier of the responder to the server application 26 to change the responding status associated with the current responder in the database to yes. The second on-screen respond object 68 may be activated by clicking on it with a pointing device, such as a mouse, or by touching it on a touch screen. After activation of the second on-screen availability object 62, the mobile application 52 may also provide an indication to the responder that he has just responded to the emergency call.

The mobile application 52 may also display a list of personnel who have indicated that they are responding to a given emergency call. The user may select a “Current Call Respondents” option from the first page 54, and the mobile application 52 may display a seventh page 70, as seen in FIG. 20, which includes a list of names of responder personnel whose responding status is yes. The seventh page 70 may also display an indication of the total number of personnel who are responding to the emergency call. In some embodiments, the mobile application 52 may send a request to the server application 26 on a regular basis to update the list of responders responding to the emergency call. In other embodiments, the server application 26 may automatically send a new list to all responders when any one of the responders changes his responding status to yes.

In some embodiments of the system 10, the electronic device14 may not be able to execute, or may not have access to, the mobile application 52. Alternatively, the responder may have an electronic device 14 capable of executing the mobile application 52, but may choose not to do so. In such embodiments, the electronic device 14 may still have the ability to transmit a text message to a given phone number. The text message may be transmitted utilizing the Short Message Service (SMS), or the like, as is known in the art. The server application 26, or other applications, programs, software, or hardware in communication with the server application 26, may receive the text message from the electronic device 14. The text message may include codes or keywords that direct the server application 26 to change the availability status in the database. The codes may be alphanumeric and the keywords may include commonly-used words. For example, a first code or keyword may change to the availability status to available, while a second code or keyword may change the status to unavailable.

The system 10 may operate as follows. Access to the server application 26 may be offered as a service provided by a monitoring company. The server 12 may be maintained by a service provider or host such as an Internet service provider (ISP). The electronic devices 14 may be owned or rented by the responder personnel. When a public service group, such as fire or police departments or medical centers, wants to utilize the server application 26, a user, who is a member of the public service group, accesses the web site associated with the server application 26. The user may be presented with the first page 28 of the server application 26, as shown in FIG. 4, and may supply the requested information to establish an account. The user then may add information regarding departments and groups on the second page 32, as shown in FIG. 5, and may add information regarding the responder personnel on the third page 34, as shown in FIG. 6.

The web site associated with the server application 26 may also include a copy of the mobile application 52. All of the responder personnel may access the web site in order to download the mobile application 52. The responder personnel may then install the mobile application 52 on an electronic device 14. When a responder is ready to establish his availability status, he may either access the server application 26 or the mobile application 52.

The responder may access the server application 26 with a web browser and may log in or otherwise identify himself with a unique identifier, such as a user name or identification number. The responder may then click the menu bar 30 to select “Page In/Out”. The fifth page 38, as shown in FIG. 8, may be displayed with the first current status indicator 42 for the name of the responder personnel associated with the unique identifier. If the current availability status is correct, then the responder may take no action. Otherwise, the responder may activate the first on-screen availability object 40 to change the availability status and, in turn, the first current status indicator 42. The availability status may then be changed in the database. Whenever the responder changes his status from available to unavailable, the server application 26 may display the sixth page 39 shown in FIG. 9. The responder may then select a period of time for which he will be unavailable. The time may then be entered as the page out duration associated with the name of the current responder in the database. The time of day that the change occurred may be entered as the page out time of day in the database as well.

To change his availability status, the responder may also access the mobile application 52 on his electronic device 14. He may simply execute the mobile application without logging in to any program, server, or system. Presented with the first page 54, as seen in FIG. 13, the responder may select the option for “Page Out/Page In”. The responder may then be presented with the fourth page 60, as shown in FIGS. 16-17, which displays his current availability status in the second current status indicator 64 that was retrieved from the server application 26. If the current availability status is correct, then the responder may take no action. Otherwise, the responder may activate the second on-screen availability object 62 to change the availability status and, in turn, the second current status indicator 64. Whenever the responder changes his status from available to unavailable, the mobile application 52 may display the fifth page 61 shown in FIG. 18. The responder may then select a period of time for which he will be unavailable. The time may then be recorded as the page out duration to be associated with the name of the current responder in the database. The time of day that the change occurred may be recorded as the page out time of day to be entered in the database as well. The mobile application 52 may then send a signal, an instruction, or data to the server application 26 to change the availability status, the page out duration, and the page out time of day associated with the current responder in the database. The mobile application 52 may also send a signal, an instruction, or data to the server application 26 that indicates the identity of the current responder, such as a user name or identification number.

The mobile application 52 may also track the current location of the electronic device 14 and in turn, the responder, as discussed above. The tracking may occur constantly or at regular intervals. If it is determined that the electronic device 14 is outside of the on-call area, then the mobile application 52 may automatically communicate with the server application 26 to change the availability status of the responder to unavailable. The mobile application 52 may also update all of the on-screen status indicators on the electronic device 14 and may display an alert or a prompt to the responder that his status has changed.

When any user, such as a fire chief, a police captain, or the like, wishes to review the availability status of the responder personnel for a group or a department, he may either access the server application 26 or the mobile application 52. In the server application 26, the user may select the “Availability” option on the menu bar 30 and the seventh page 44 may be presented, as seen in FIG. 9. The user may then select a group or department from the pull-down menu and the server application 26 may retrieve from the database the list of selected names along with an indication of the availability status, the page out time of day, and the page out duration of each name. Furthermore, the seventh page 44 may provide an indication of the total number of responder personnel who are available to respond to a call.

In the mobile application 52, the user may be presented with the first page 54 and may select the option “Availability”. The mobile application 52 may then present the second page 56, shown in FIG. 14, which displays a list of names, typically belonging to the group of which the user is a member, along with an indication of the availability status, the page out time of day, and the page out duration of each name. The second page 56 may also display an indication of the total number of responder personnel who are available to respond to a call.

A responder may utilize either the server application 26 or the mobile application 52 to respond to an emergency call. To access the server application 26, the responder may log in to the web site associated with the server application 26 and may select “RESPOND to Current Call” from the menu bar 30. The server application 26 may display the eighth page 46, as seen in FIG. 11, which includes the first on-screen respond object 48. The responder may activate the first on-screen respond object 48 by clicking it or touching it. The server application 26 may then change the responding status associated with the name of the responder in the database to yes.

With the mobile application 52, the responder may select “RESPOND to Current Call” from the first page 54, and the mobile application 52 may display the sixth page 66 with the second on-screen respond object 68, as shown in FIG. 19. The responder may activate the second on-screen respond object 68, by touching it or clicking on it, and in turn, the mobile application 52 may communicate with the server application 26 to change the responding status associated with the name of the responder in the database to yes. The mobile application 52 may also provide an indication to the responder that he has just responded.

Any user may view a list of names of responders who are responding to the current emergency with either the server application 26 or the mobile application 52. In the server application 26, the user may select “Respondents” from the menu bar 30 and may view the ninth page 50, as seen in FIG. 12, with the list of names whose responding status is yes. The server application 26 may update the list on the ninth page 50 as the responding status of the responders changes. In the mobile application 52, the user may select “Current Call Respondents” from the first page 54, and the mobile application 52 may display the seventh page 70, as seen in FIG. 20, with the list of names of responder personnel whose responding status is yes. In some embodiments, the list may be updated by the mobile application 52 querying the server application 26 on a regular basis for updates to the responding status. In other embodiments, the list may be updated by the server application 26 automatically sending an update to the mobile applications 52 of all of the responders whenever a responder updates his responding status.

A user may create announcements by using the server application 26 and selecting the “Announcements” option from the menu bar 30. In some embodiments, the ability to create announcements may be limited to certain users. The server application 26 may present the fourth page 36, as shown in FIG. 7, which allows announcements to be created and recipients of the announcements to be specified. The fourth page 36 may also display a list of recent announcements. The mobile application 52 may allow users to view announcements by selecting the “Announcements” from the first page 54. The mobile application 52 then presents the third page 58 which displays a list of the announcements, as seen in FIG. 13.

In embodiments in which the electronic device 14 does not execute, or access, the mobile application 52, the responder may send a text message to a phone number associated with the system 10 or the monitoring company providing the service in order to change his availability status. To change his status to available, the responder may text a first code or a keyword, such as “available”, to the phone number. To change his status to unavailable, the responder may text a second code or keyword, such as “unavailable”, to the phone number. Texting a message as described may change or update the availability status of the responder in the database.

The current invention is easy for a responder to use in order to establish, update, or change his availability status. Typically, the responder has one of the mobile electronic devices 14 which he keeps with him most of the time. The mobile application 52 may be running on the electronic device 14 in the background constantly. Thus, to change his availability status, all the responder has to do is access the mobile application 52 on his electronic device 14. He may activate the second on-screen availability object 62 by touching the screen 20 of the electronic device 14 in the area of the second on-screen availability object 62. Referring to FIGS. 16-17, if the responder was previously unavailable, then activating the second on-screen availability object 62 changes his status and the second current status indicator 64 to available. If the responder was previously available, then activating the second on-screen availability object 62 changes his status and the second current status indicator 64 to unavailable.

Since the mobile application 52 transmits the status and an identifier to the server application 26 which accesses the database, the availability status is updated almost immediately. The system 10 eliminates the possibility of error from a human operator or scheduler because the availability status and an identifier are both sent from the mobile application 52 to the server application 26 to update the availability status of the associated name in the database. Moreover, because the second on-screen availability object 62 only performs one function, it is easy to understand and use. In addition, if the responder leaves the on-call area, his electronic device 14 may sense that fact, and the mobile application 52 may automatically send a change in the availability status of the responder to the server application 26.

In a similar fashion to updating his availability status, the responder can also use the current invention to change his responding status quickly and easily. When the responder receives an emergency call, all the responder has to do is access the mobile application 52 on his electronic device 14 and activate the second on-screen respond object 68 by touching the screen 20 of the electronic device 14 in the area of the second on-screen respond object 68. The database of the server application 26 is updated as soon as the mobile application 52 sends the change in the responding status of the responder.

The current invention also provides up to the moment status information about the availability of all of the responders of a group or a department. Thus, a captain, a commander, or a shift scheduler can see at a glance if he has enough responders who are available to answer an emergency or critical situation. If necessary, he can contact the unavailable responders to request them to change their status.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for monitoring an availability status of responder personnel, the system comprising:
an electronic device including a screen and executing a mobile application configured to communicate with a server maintaining a list of responder personnel names and an availability status associated with each name, the mobile application displaying on the screen an on-screen availability object for establishing the availability status of a responder and a current status indicator for indicating the current availability status, such that activating the on-screen availability object changes the current status indicator and establishes the availability status of the responder as of the moment the on-screen availability object is activated without any action required by an operator or scheduler.

2. The system of claim 1, wherein the mobile application displays on the screen an on-screen respond object for establishing a responding status to a current emergency call associated with each name, such that activating the on-screen respond object changes the responding status to yes.

3. The system of claim 1, wherein the mobile application displays on the screen a list of responder personnel names who have a responding status to a current emergency call associated with each name of yes.

4. The system of claim 1, wherein the mobile application is further configured to determine when the electronic device is outside of an on-call area and to change the availability status to unavailable when the electronic device is outside of the on-call area.

5. The system of claim 1, wherein activation of the on-screen availability object toggles the availability status and the current status indicator.

6. The system of claim 1, wherein electronic device transmits the availability status to the server upon activation of the on-screen availability object.

7. The system of claim 1, wherein the on-screen availability object is activated by touching the object on the screen or by clicking on the object with a pointing device.

8. The system of claim 1, wherein the mobile application further displays on the screen the list of responder personnel names and an indication of the availability status of each name.

9. The system of claim 8, wherein the indication of the availability status of each name includes a first indication for the responder being available and a second indication for the responder being unavailable.

10. The system of claim 1, wherein the mobile application further displays on the screen an indication of the total number of responder personnel names with the availability status of available.

11. The system of claim 1, wherein the electronic device is further configured to transmit a text message with codes or keywords, such that a first code or keyword changes the availability status to available and a second code or keyword changes the availability status to unavailable.

12. A system for monitoring an availability status of responder personnel, the system comprising:
a server configured to maintain a list of responder personnel names and an availability status associated with each name, the server executing a server application configured to display on a web page a first on-screen availability object for establishing the availability status of a responder and a first current status indicator for indicating the current availability status, such that activating the first on-screen availability object changes the first current status indicator and establishes the availability status of the responder as of the moment the first on-screen availability object is activated without any action required by an operator or scheduler, the server application further configured to receive communication from a mobile application executed by an electronic device such that the availability status of the responder is modified when the responder activates a second on-screen availability object on the electronic device.

13. The system of claim 12, wherein activation of either the first on-screen availability object or the second on-screen availability object toggles the availability status.

14. The system of claim 12, wherein electronic device transmits the availability status to the server upon activation of the second on-screen availability object.

15. The system of claim 12, wherein the server application displays the list of responder personnel names and an indication of the availability status of each name.

16. The system of claim 15, wherein the indication of the availability status of each name includes a first indication for the responder being available and a second indication for the responder being unavailable.

17. A non-transitory computer readable storage medium with an executable program stored thereon for monitoring an availability of responder personnel, wherein the program instructs a processing element to perform the following steps:
accessing a database to retrieve a list of responder personnel names and an availability status associated with each name;
displaying on a screen of an electronic device the list of responder personnel names and an indication of the availability status of each name;
displaying on the screen an on-screen availability object for establishing the availability status of a responder and a current status indicator for indicating the current availability status; and
receiving an activation of the on-screen availability object from the responder which changes the current status indicator and establishes the availability status of the responder as of the moment the on-screen availability object is activated.

18. The non-transitory computer readable storage medium of claim 17, wherein the program further includes the steps of displaying on the screen an on-screen respond object for establishing a responding status to a current emergency call associated with each name, and receiving an activation of the on-screen respond object which changes the responding status to yes.

19. The non-transitory computer readable storage medium of claim 17, wherein the program further includes the steps of determining when the electronic device is outside of an on-call area, and changing the availability status to unavailable when the electronic device is outside of the on-call area.

20. The non-transitory computer readable storage medium of claim 17, wherein the program further includes the step of transmitting the availability status to the database after the activation of the on-screen availability object.

21. The non-transitory computer readable storage medium of claim 17, wherein the indication of the availability status of each name includes a first indication for the responder being available and a second indication for the responder being unavailable.

22. The non-transitory computer readable storage medium of claim 17, wherein activation of the on-screen availability object toggles the availability status.

23. The non-transitory computer readable storage medium of claim 17, wherein the program further includes the step of displaying on the screen an indication of the total number of responder personnel names with the availability status of available.

24. The non-transitory computer readable storage medium of claim 17, wherein receiving the activation of the on-screen availability object includes receiving either a touch on the screen in the location of the on-screen availability object or a click from a pointing device on the screen in the location of the on-screen availability object.
